(19) United States
(12) Patent Application Publication
(10) Pub. No.: US 2018/0312937 A1
(43) Pub. Date: Nov. 1, 2018

(54) Seamless Line Pipe Resistant to Corrosion by CO2/H2S and Sulfate-Reducing Bacteria and Manufacturing Method Thereof

(71) Applicants: China University of Petroleum-Beijing, Beijing City (CN); Baoshan Iron & Steel Co., Ltd., Shanghai City (CN)

(72) Inventors: Haobo Yu, Beijing City (CN); Changfeng Chen, Beijing City (CN); Zhonghua Zhang, Beijing City (CN); Yanzhao Yu, Beijing City (CN); Yameng Qi, Beijing City (CN); Yuan Kuang, Beijing City (CN); Ruijing Jiang, Beijing City (CN); Xiaolan Jia, Beijing City (CN); Junying Zhang, Beijing City (CN); Lianwu Yu, Beijing City (CN); Yaoheng Liu, Beijing City (CN)

(21) Appl. No.: 15/963,219

(22) Filed: Apr. 26, 2018

(30) Foreign Application Priority Data
Apr. 27, 2017 (CN) 201710284976.X

(51) Int. Cl. C21D 9/14; C21D 9/08; C21D 8/10; C21D 6/00; C22C 38/50; C22C 38/44; C22C 38/42; C22C 38/04; C22C 38/02; C22C 38/00; E21B 17/00; F16L 58/00

(52) U.S. Cl. CPC C21D 9/14; F16L 58/00; C21D 8/105; C21D 6/002; C21D 6/005; C21D 6/008; C22C 38/50; C22C 38/44; C22C 38/42; C22C 38/04; C22C 38/02; C22C 38/005; C22C 38/002; E21B 17/00; C21D 9/085

(57) ABSTRACT

The invention provides a seamless line pipe with excellent resistance against corrosion by CO₂—H₂S-SRB. The line pipe comprises, by mass fraction, C: 0.03 to 0.10%, Si: 0.1 to 0.5%, Mn: 0.10% to 1.50%, P: 0.02% or less, S: 0.005% or less, Cr: 1.0 to 4.0%, Ni: 0.1 to 1.5%, Cu: 0.15 to 2.0%, Mo: 0.05 to 0.4%, Ti: 0.01 to 0.05%, RE: 0.05 to 0.1%, and balance of Fe. After smelting, rolling into a billet, and piercing and rolling into a pipe, the resultant steel pipe is heated to 920 to 1000° C. and kept for 0.3 to 1 hour depending on the thickness of the steel pipe wall, and then subjected to rapid cooling and tempering heat treatment. The seamless line pipe can be used in the field of oil and gas fluid transportation and the like.

### FIELD OF THE INVENTION

The present invention relates to a seamless line pipe used for transporting oil and gas in oil and gas fields. In particular, the present invention relates to a seamless line pipe suitable for use in an environment having carbon dioxide (CO₂), hydrogen sulfide (H₂S), and sulfate-reducing bacteria (SRB), which has excellent resistance against uniform corrosion, particularly excellent resistance against pitting corrosion, and a manufacturing method thereof.

### BACKGROUND OF THE INVENTION

With the deepening of oil and gas field exploitation and the increasingly harsh working conditions, the produced oil and gas are often accompanied by corrosive gases like CO2 and H2S. Gathering line pipes are mainly used to connect the pipelines between an oil and gas well and an integrated oil and gas processing apparatus, and to transport oil and gas that have not been subjected to pretreatment of dehydration, desalination, and desulfurization. Therefore, gathering line pipes serve under rather stringent conditions. In recent years, due to the frequent leakage accidents of pipelines caused by the CO2-H2S-SRB coexistence environment in domestic oil and gas fields, great economic losses and environmental pressure have been brought to the oil and gas fields. At present, anti-corrosion seamless pipelines that are resistant to only CO2/H2S corrosion cannot effectively solve the perforation problems caused by the CO2-H2S-SRB coexistence environment. Therefore, a seamless line pipe resistant to CO2-H2S-SRB corrosion is highly desired in the oil and gas field industry.

Japanese patent document entitled “A line pipe with excellent acid and corrosion resistance” with publication date of Oct. 15, 1996 and publication No. JP8269623 discloses a line pipe with a chemical element composition of: C≤1.06%, Si 0.01 to 0.50%, Mn 0.1 to 2.0%, P≤1.01%, S≤1.003%, Cr 0.25 to 1.0%, Al 0.01 to 0.10%, Ca≤1.006%, Pcm (%)≤0.18%. The line pipe belongs to low Cr anti-CO2/H2S corrosion line pipe, but its Cr content of only 0.25 to 1.0% has limited contribution to pitting corrosion resistance, not capable of resisting uniform corrosion and localized corrosion in a CO2-H2S-SRB coexistence environment.

Chinese patent document entitled “X70QS seamless line pipe with anti-HIC performance” with publication date of Jun. 20, 2012 and publication No. CN101921964B discloses a seamless line pipe with a chemical composition in mass percentage of C 0.06 to 0.14%, Si 0.20 to 0.45%, Mn 1.00 to 1.30%, P≤0.015%, S≤0.003%, Cr 0.05 to 0.30%, Mo 0.05 to 0.30%, Al 0.015 to 0.060%, N 0.003 to 0.010%, Nb 0.030-0.50%, V 0.05-0.09%, Ni, Cu as residual elements in the steel, with limited contents of Ni≤0.10%, Cu≤0.20%, and balance of Fe and impurities. The line pipe has high strength, excellent impact performance and good anti-HIC performance. However, it does not have excellent resistance against CO2-SRB corrosion.

Chinese patent document entitled “Anti-corrosion seamless gathering line pipe and manufacturing method thereof” with publication date of Mar. 30, 2016, and publication No. CN103147006B discloses a gathering line pipe with a chemical composition in mass percentage of C 0.04 to 0.10%, Si 0.1 to 0.35%, Mn 0.3 to 0.8%, Cr 0.55 to 1.25%, W 0.06 to 0.55%, Al 0.01 to 0.05%, Ca 0.0005 to 0.006%, Cu≤0.2%, Ni≤0.2%, V≤0.05%, Ti≤0.03%, Nb≤0.05%, and balance of Fe and other unavoidable impurities. The gathering line pipe has high strength, excellent welding performance, good impact properties and other comprehensive mechanical properties, together with excellent anti-CO2/H2S corrosion resistance. However, it does not have corrosion resistance against a CO2-H2S-SRB coexistence condition.

According to the study of the present invention, a seamless line pipe having high strength and excellent resistance against CO2-H2S-SRB corrosion can be obtained with appropriate configuration of alloy elements together with appropriate heat treatment conditions.

### SUMMARY OF THE INVENTION

In view of the above technical problems, the object of the present invention is to provide a seamless line pipe with high strength and excellent resistance against CO2-H2S-SRB corrosion and a manufacturing method thereof.

After studying the relationship among the composition, structure and properties of the material, the inventor found that the performance of the passivation film on the steel surface during CO2-H2S-SRB corrosion is critical while the addition of Cr, Ni, and Cu may improve the performance of the passivation film. The present invention is based on the above findings and its main content is a line pipe comprising the following:

The seamless pipe comprises, by mass fraction, C: 0.03 to 0.10%, Si: 0.1 to 0.5%, Mn: 0.10% to 1.50%, P: 0.02% or less, S: 0.005% or less, Cr: 1.0 to 4.0%, Ni: 0.1 to 1.5%, Cu: 0.15 to 2.0%, Mo: 0.05 to 0.4%, Ti: 0.01 to 0.05%, Re: 0.05 to 0.1%, and balance of Fe.

After smelting, rolling into a billet, piercing and rolling into a pipe followed by quenching+tempering (tempering temperature of 500-700° C.), the line pipe is qualified by inspection and can then be used as a qualified line pipe.

Description is now provided for each item in details in the following:

1) Alloy Composition (Wherein all Contents in Percentage are Mass Fractions)
C: 0.03 to 0.10%
C is beneficial in increasing the strength of the steel, but carbides of the alloying elements tend to precipitate at the grain boundary when the C content is too high, reducing the corrosion resistance of the steel. In addition, C will significantly increase the welding crack sensitivity of steel. Therefore, C must be limited to 0.03 to 0.10%;
Si: 0.1% to 0.5%
Si is an effective deoxidizer in steelmaking. In order to increase steel strength and ensure deoxidation efficiency, its content must be kept at 0.1% or more; when the content exceeds 0.5%, the tendency of cold-brittleness of steel will significantly increase, and thus the Si content should be limited to 0.5% or less;
Mn: 0.10% to 1.50%
Mn is advantageous in expanding the austenite phase zone, increasing hardenability, and refining the grains. Excess Mn has a significant impact on welding performance and hot workability. According to the study of the present invention, it is suitable to control the Mn content at 0.10% to 1.50%;
S: 0.005% or less
S is a harmful element in steel, and its presence has an adverse effect on the corrosion resistance, hot workability, toughness and the like of the steel. Therefore, it is necessary to limit the S content to 0.005% or less, preferably 0.003% or less;
P: 0.02% or less
P is a harmful element in steel, and its presence has an adverse impact on the corrosion resistance, toughness and the like of the steel. Therefore, it is necessary to limit the P content to 0.02% or less, preferably 0.012% or less;
Cr: 1.0 to 4.0%
The addition of Cr can greatly increase the capability of steel species in resistance to local corrosion and uniform corrosion. However, in the embodiment of the present invention, it is not necessarily better as the Cr content is higher, because when the Cr content is too high, the weldability of the steel species decreases, and segregation of Cr carbides at the grain boundary tends to result in the decrease in sulfur resistance of the steel species. Therefore, the Cr content is designed at 1.0 to 4.0%;
Ni: 0.1 to 1.5%
Ni can significantly improve the performance of passivation film and improve the corrosion resistance of the steel species. According to the study of the present invention, it is appropriate to control the Ni content at 0.1% to 1.5%;
Cu: 0.15 to 2.0%
Cu can improve the resistance of the steel against atmospheric corrosion and microbial corrosion, although excessive Cu may lead to cracks during hot processing; as such, it is necessary to limit Cu to 2% or less;
Mo: 0.05 to 0.4%
Mo will effectively increase the resistance of steel against pitting corrosion. Also, Mo has a good solid solidification enhancing effect, which is advantageous in improving the performance of the steel. According to the study of the present invention, it is appropriate to control the Ni content at 0.05 to 0.4%;
Ti: 0.01 to 0.05%
Ti is effective in grain refinement, and can also improve welding performance. According to the study of the present invention, the Ni content is controlled at 0.01 to 0.05%;
RE: 0.05 to 0.1%
RE: The addition of rare earth elements can effectively improve the toughness of steel species.
When the content of rare earth elements exceeds 0.1%, the weldability of the steel species will be deteriorated. Therefore, the RE content is limited to 0.05% to 0.10%; The balance is Fe.

2) Manufacturing Process
The procedure of the manufacturing process of the line pipe according to the present invention is as follows:
(1) After smelting, the molten steel is cast into an ingot, and forged (or rolled) into a billet;
(2) The billet is heated to 1150 to 1280° C. and kept for 1 to 4 hours depending on the size of the billet, and then pierced, continuously rolled, and reduced (fixed) in diameter by tension into a pierced pipe;
(3) The resultant pierced pipe is heated to 920 to 1000° C. and kept for 0.3 to 1 hour depending on the thickness of the pierced pipe wall, and then subjected to rapid cooling (water-cooled or oil-cooled treatment)+tempering (at a tempering temperature of 500° C. to 700° C. to eliminate internal stress as much as possible and to achieve sufficient toughness given that strength is ensured) heat treatment; upon qualified by performance inspection, it becomes a corresponding product ready for shipping out; and the seamless pipe is thus manufactured.

The present invention has the following advantages over other line pipes:
1) The line pipe according to the present invention can achieve a yield strength of 300 MPa to 500 MPa according to the heat treatment process, as well as excellent toughness (full size impact energy ≥50 J at 0° C.);
2) The line pipe of the present invention has excellent corrosion resistance against CO₂—H₂S-SRB. The uniform corrosion rate is less than 0.13 mm/a and the pitting corrosion rate is less than 0.9 mm/a in a corrosion test for 168 h under CO₂, H₂S and SRB coexistence environment at 38° C. with a CO₂ partial pressure of 0.1 MPa and an H₂S partial pressure of 0.1 MPa.

In summary, the present invention can provide a seamless line pipe with excellent resistance against CO2-H2S-SRB corrosion and can be used in the field of oil and gas fluid transportation.

### DETAILED DESCRIPTION OF THE INVENTION

Hereinafter, the technical solutions in the examples of the present invention are clearly and fully described. Obviously, the examples described are only a part but not all of the examples of the present invention. Any other examples obtained by a person of ordinary skill in the art based on the examples of the present invention without making creative efforts shall fall within the scope of the present invention.

The compositions of the examples are shown in Table 1.

TABLE 1
Compositions of the examples (wt/%)

| | Composition | | | | | | | | | | | | |
|---|---|---|---|---|---|---|---|---|---|---|---|---|---|
| Item | No. | C | Si | Mn | P | S | Cr | Ni | Cu | Mo | Ti | RE | Note |
| Inventive | A | 0.03 | 0.2 | 0.25 | 0.015 | 0.002 | 2.5 | 0.6 | 0.3 | 0.3 | 0.03 | 0.08 | Examples |
| Examples | B | 0.05 | 0.2 | 1.4 | 0.015 | 0.002 | 1.3 | 1.4 | 1.7 | 0.1 | 0.04 | 0.06 | of the |
| | C | 0.09 | 0.2 | 0.9 | 0.015 | 0.002 | 3.7 | 1.0 | 1.0 | 0.2 | 0.03 | 0.09 | present |
| | D | 0.04 | 0.16 | 0.35 | 0.015 | 0.002 | 2.6 | 0.3 | 0.4 | 0.25 | 0.02 | 0.07 | invention |
| | E | 0.07 | 0.21 | 0.4 | 0.015 | 0.002 | 2.0 | 0.8 | 0.8 | 0.32 | 0.03 | 0.08 | |
| | F | 0.03 | 0.2 | 1.2 | 0.015 | 0.002 | 3.0 | 0.3 | 1.5 | 0.18 | 0.04 | 0.06 | |
| Comparative | a | 0.05 | 0.18 | 0.6 | 0.015 | 0.002 | 2.8 | 0.9 | 0.05 | 0.3 | 0.03 | 0.08 | Example |
| Examples | | | | | | | | | | | | | in which |
| | | | | | | | | | | | | | Cu |
| | | | | | | | | | | | | | exceeds |
| | | | | | | | | | | | | | its lower |
| | | | | | | | | | | | | | limit |
| | b | 0.07 | 0.24 | 1.0 | 0.042 | 0.006 | 1.2 | 1.3 | 1.2 | 0.15 | 0.04 | 0.06 | Example |
| | | | | | | | | | | | | | in which P, |
| | | | | | | | | | | | | | S exceeds |
| | | | | | | | | | | | | | its upper |
| | | | | | | | | | | | | | limit |
| | c | 0.28 | 0.28 | 0.9 | 0.015 | 0.002 | 4.4 | 0.8 | 0.6 | 0.28 | 0.02 | 0.07 | Example |
| | | | | | | | | | | | | | in which C |
| | | | | | | | | | | | | | exceeds |
| | | | | | | | | | | | | | its upper |
| | | | | | | | | | | | | | limit |

Line pipes with a size of 219*14.5 (i.e., diameter*wall thickness) were made of alloys having the compositions shown in Table 1 with the specific procedures as follows:

Alloys having the above compositions were casted into ingots which were then forged into φ300 mm circular billets;

The billets were heated to 1250° C. and kept for 3 hours, and then subjected to a general hot-rolled line pipe production process of piercing, hot rolling, and fixing in diameter to produce pierced pipes;

The resultant pierced pipes were heated to 920 to 1000° C. and kept for 40 minutes before they were quenched using different cooling techniques. Then, each of the steel species was subjected to tempering at 500 to 700° C. for 1 hour. The heat treatment process, performance and corrosion resistance of each line pipe are shown in Table 2.

TABLE 2
Organization, mechanical properties, corrosion performance of Examples

| | | | | | Impact | Uniform | Pitting | |
|---|---|---|---|---|---|---|---|---|
| | | Quenching | Tempering | Yield | energy/ | corrosion | corrosion | |
| | Composition | temperature/ | temperature/ | strength | 0° C., full | rate | rate | |
| Item | No. | ° C. | ° C. | Rp0.2/MPa | size | (mm/a) | (mm/a) | Note |
| Inventive | A | 930 | 650 | 398 | 70 | 0.0983 | 0.6572 | Examples |
| Examples | B | 950 | 600 | 430 | 65 | 0.1023 | 0.8623 | of the |
| | C | 980 | 580 | 498 | 54 | 0.0730 | 0.3219 | present |
| | D | 960 | 695 | 320 | 72 | 0.0943 | 0.6552 | invention |
| | E | 980 | 600 | 468 | 60 | 0.1223 | 0.8981 | |
| | F | 930 | 550 | 420 | 55 | 0.0867 | 0.4731 | |
| Comparative | a | 950 | 600 | 418 | 68 | 0.5631 | 1.8573 | Example |
| Examples | | | | | | | | in which |
| | | | | | | | | Cu |
| | | | | | | | | exceeds |
| | | | | | | | | its lower |
| | | | | | | | | limit |
| | b | 980 | 630 | 456 | 32 | 0.3621 | 1.2034 | Example |
| | | | | | | | | in which |
| | | | | | | | | P, S |
| | | | | | | | | exceeds |
| | | | | | | | | its upper |
| | | | | | | | | limit |
| | c | 950 | 600 | 530 | 28 | 0.3819 | 1.4098 | Example |
| | | | | | | | | in which |
| | | | | | | | | C |
| | | | | | | | | exceeds |
| | | | | | | | | its upper |
| | | | | | | | | limit |

The data in each category in Table 2 were measured as follows:

The data for yield strength was obtained by processing the prepared line pipe into an API arc sample, and calculating the average number after the API standard test;

The data for full-size Charpy V-shaped impact absorption energy was obtained by calculating the average number after the GB/T 229 standard test performed on a full-size V-shaped impact test specimen with a cross-sectional area of 10*10*55 taken from the prepared steel pipes;

The corrosion test was conducted in an CO2, H2S, SRB coexistence environment. The samples were immersed in the liquid in a vessel at a temperature of 38° C., with a partial pressure of CO2 of 0.1 MPa and a partial pressure of H2S of 0.1 MPa, for a test duration of 168 h. The weights of the samples before and after the test were compared, and the uniform corrosion rates were calculated. The pitting corrosion rates were obtained by analysis of the cross-section area of the pitting holes.

What is claimed is:

1. A seamless pipe resistant to corrosion by CO₂, H₂S and sulfate-reducing bacteria, characterized in that the seamless pipe comprises, by mass fraction, C: 0.03 to 0.10%, Si: 0.1 to 0.5%, Mn: 0.10% to 1.50%, P: 0.02% or less, S: 0.005% or less, Cr: 1.0 to 4.0%, Ni: 0.1 to 1.5%, Cu: 0.15 to 2.0%, Mo: 0.05 to 0.4%, Ti: 0.01 to 0.05%, RE: 0.05 to 0.1%, and balance of Fe.

2. The seamless pipe according to claim 1, wherein the S content is 0.003% or less.

3. The seamless pipe according to claim 1, wherein the P content is 0.012% or less.

4. A method for manufacturing a seamless pipe, comprising the following steps:
a) after smelting, a molten steel having a composition of the seamless pipe according to claim 1 is cast into an ingot, and forged or rolled into a billet;
b) the billet is heated to 1150 to 1280° C. and kept for 1 to 4 hours depending on a size of the billet, and then pierced, continuously rolled, and reduced or fixed in diameter by tension into a pierced pipe; and
c) the resultant steel pipe is heated to 920 to 1000° C. and kept for 0.3 to 1 hour depending on a thickness of a steel pipe wall, and then subjected to rapid cooling and tempering heat treatment to give a seamless pipe.

5. The method according to claim 4, wherein rapid cooling is water-cooled or oil-cooled treatment.

6. The method according to claim 4, wherein a tempering temperature is 500° C. to 700° C.

7. The method according to claim 4, wherein a yield strength of the seamless pipe is 300 MPa to 500 MPa.

8. The method according to claim 4, wherein toughness is full-size impact energy ≥50 J at 0° C.

9. The method according to claim 4, wherein a corrosion test for 168 h under CO₂, H₂S and SRB coexistence environment at 38° C. with a CO₂ partial pressure of 0.1 MPa and an H₂S partial pressure of 0.1 MPa, a uniform corrosion rate is less than 0.13 mm/a and a pitting corrosion rate is less than 0.9 mm/a.

10. Use of the seamless pipe according to claim 1 in the field of oil and gas fluid transportation.

11. Use of the seamless pipe according to claim 2 in the field of oil and gas fluid transportation.

12. Use of the seamless pipe according to claim 3 in the field of oil and gas fluid transportation.
